(19) United States
(12) Patent Application Publication
(10) Pub. No.: US 2001/0043160 A1
(43) Pub. Date: Nov. 22, 2001

(54) PC card having an antenna unit

(76) Inventors: Yuji Hirai, Tokyo (JP); Kiyoshi Sato, Tokyo (JP); Kazuhiro Homma, Tokyo (JP); Hidenori Aizawa, Tokyo (JP)

Correspondence Address: Leighton K. Chong, Ostrager Chong & Flaherty, Suite 1200, 841 Bishop Street, Honolulu, HI, 96813-3908, US

(21) Appl. No.: 09/745,748

(22) Filed: Dec. 22, 2000

(30) Foreign Application Priority Data
May 22, 2000 (JP) 150649/2000

(51) Int. Cl. H01Q 1/24

(52) U.S. Cl. 343/702

(57) ABSTRACT

An antenna storage part 22c is provided on a thin board or plate-like main body 2 of the PC card 1 which most part of the top and bottom is covered by the radio wave shield material 10, 12. The extendible antenna unit 3 is inserted in this storage part of the antenna unit. In time of using, at least the antenna part 32a of the antenna unit 3 is expanded outside of the radio wave shield material of the main body 2 and retained in the expanded position to receive and send the radio wave. In time of not using, the antenna unit 3 is stored and retained in the stored position where the substantially entire antenna unit 3 is stored in the main body 2.

### TECHNICAL FIELD TO WHICH THE INVENTION BELONGS

The invention relates to a PC card having an antenna unit, in particular to a PC card for achieving compactness and thinness.

### PRIOR ART

In the office, in constructing the wireless LAN, set an access point device to receive and send data is set on the server side of the LAN. On the other hand, a PC card having an antenna unit is inserted to a PC card slot of a computer, and by corresponding between the two devices, the data is received and send. Moreover, PHS card has a similar usage and the principle of the invention includes this usage.

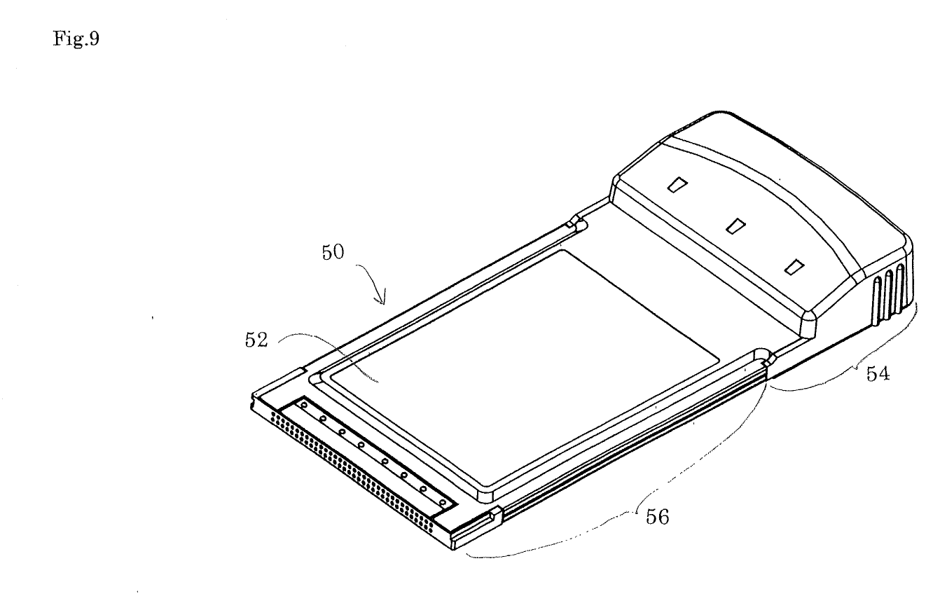

The FIG. 9 is a perspective view of a typical conventional PC card having an antenna unit. As shown in the drawing, the conventional PC card having an antenna unit 50 is manufactured covered both sides with a metallic shield cover 52 to protect a substrate inside the card and also to shield electronic devices such as semiconductors equipped with the substrate from outside electromagnetic waves. On the other hand, an antenna of a antenna portion 54, which receives and sends the radio wave, is not able to do so (receives and sends the radio wave) when located in the part where it is covered by the metallic shield. For this reason, the antenna portion 54 is build in a way to stick out of an end of a thin-boarded main body of a PC card 56. Because the size and the thickness of the PC card slot of the computer is set according to the standard, the antenna portion 54 having large thickness had to be equipped in this way. This conventional antenna portion 54 comprises a connector part and an antenna part to connect electrically with a main body of the PC card.

### PROBLEMS TO BE SOLVED BY THE INVENTION

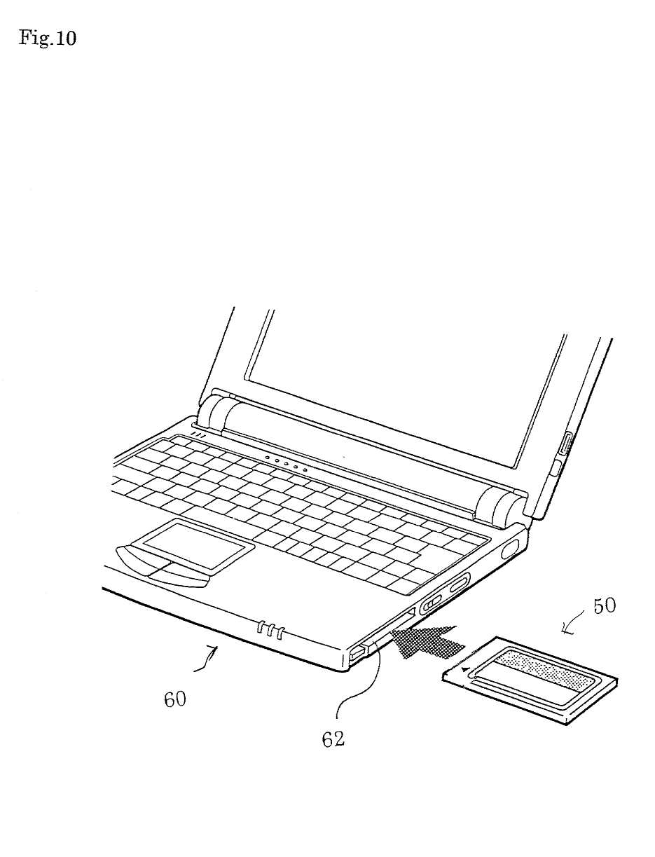

Recently, due to the spread of a note-type personal computer, as illustrated in the FIG. 10, the note-type personal computer is being frequently used in the wireless LAN equipping the PC card. For the note-type personal computer, a number of the PC card slot is limited as several functions are equipped in compact with the main body of the personal computer (usually 1-2 card slots). It is therefore, in using several PC cards, a wireless LAN PC card, that is a PC card having an antenna portion, has to be detached and kept. Usually those note-type personal computers are kept inside a carrier bag designed especially for this type of computer, all accessories relating to the computer and parts should be stored and kept in the pockets of this carrier bag. Because the carrier bag is designed with compact pockets like the personal computer itself, the PC card that is expected to be stored in this pocket is required to be small than ever before. There has been also a problem in the protection of the antenna portion from damage and other problems because it is sticking out outside the card.

It is therefore an object of the present invention to solve the problems of the aforesaid conventional PC card for the wireless LAN or a PC card having an antenna portion, and to provide a PC card having an antenna unit which achieves compactness in size and thinness.

### MEANS FOR SOLVING THE PROBLEMS

The present invention is to solve those problems and to provide a PC card having an antenna unit wherein the most of the top and bottom parts of a thin-plate (board) like main body of the card is covered by the radio wave shield material, a stored portion of the antenna unit is build in the main body; in this stored portion of the antenna unit, the PC card having the antenna unit that is possible to expand therefrom is equipped, and in time of using the computer, at least the antenna part of the antenna unit is expanded to outside of the radio wave shield material of the main body of the card, and the antenna unit is retained at an expanded position to receive and send the radio wave, and in time of not using, the entire antenna unit is substantially encapsulated inside the main body of the card and retained at a stored position.

The main body of the card and the antenna unit are manufactured as separate parts, and the antenna unit is assembled and kept in the storage part of the main body of the card. The antenna unit is designed to be retained in at least 2 positions relating to the main body of the card. The first position is the expanded position where, during on-operation, at least the antenna part of the antenna unit is expanded to outside of the radio wave shield material of the main body of the card and is possible to receive and send the radio wave between the access point device of the server.

The second position is the stored position where, during off-operation, the entire antenna unit is substantially encapsulated inside the main body of the card. After the PC card having an antenna unit in accordance with the present invention is detached from the computer, the antenna unit is stored inside the card whereby the size of the entire card is minimized by the size of the antenna unit. As a result, the card substantially becomes a thin flat board card without any projection and several cards are kept without taking much space. For the entire antenna unit is substantially stored inside the metallic material card, it is protected from the radio wave and damages.

The invention according to the claim 2 is characterized in that said PC card having the antenna unit described in the claim 1 is provided with a retainer mechanism between the main body of the PC card and the antenna unit whereby the antenna unit is kept from expanding further than the expanded position where it might be dropped off.

The antenna unit is caught and stopped in said 2 positions of the main body of the card as mentioned above, the antenna unit is designed not to fall out from the main body of the PC card, expanding further than the expanded position. However, as a device to move the antenna unit to the expanded position, generally the spring has been used and sometimes the force is too much. In this case happens, to avoid the antenna unit to fall out from the PC card, the retainer mechanism retains it and stops from moving more to outside. This retainer mechanism can be used as an engaging mechanism at the expanded position.

The invention according to the claim 3 is characterized in that in said PC card having the antenna unit claimed in the claim 2 said retainer mechanism comprises a combination of a projection build either the main body of the card or the antenna unit and an elastic bridge part which is formed as a part of the other frame structure, and is provided with a protrusion entering into an extended line of a passage where said projection passes through.

The projection built either on the main body of the card or the antenna unit, preferably on the main body of the PC card is moving linearly back and force to the other. On the extended line of this passage, said protrusion is formed with the bridge part so as to obstruct the movement thereof. Generally, this kind of the engaging mechanism or a stopper in the electric device, if the material is made of plastic, the elastic leg of a catch-lever construction engages with the protrusion. However the structure of this elastic leg had a failure drawbuds wherein it breaks easily due to the enormous moment load on the root of the leg. The bridge part which is formed as a part of the frame structure can have enough elasticity and support the load on both ends of the bridge so there is no need to worry about breaking.

The invention according to the claim 4 is characterized in that in said PC card having the antenna unit claimed in any one of the claim 1-3, the main body of the PC card and the antenna unit is electrically connected by a flexible cable.

In the PC card having an antenna unit of the present invention, the main body of the PC card and the antenna unit are manufactured as separate parts, but be means of this flexible cable, they are connected electrically.

The invention according to the claim 5 is characterized in that in said PC card having the antenna unit claimed in any one of the claims 1-3, the main body of the PC card and the antenna unit are electrically connected by a mechanical connecting pressure created by elastic connectors, which are projecting from a substrate, and the conductor pads which are equipped in the other substrate. When the antenna unit is in the expanded position, the main body and the antenna unit are electrically connected, and when the antenna unit is moved to the stored position, the connection is cut off.

When the antenna unit is in the expanded position, that is in an operation mode or only the PC card having the antenna unit is being used, the antenna unit and the main body are electrically connected. For example, in the case of carrying the note-type personal computer in the situation when the PC card is still inserted, the antenna unit is stored in the main body without receiving radio wave and accidentally operating.

The invention according to the claim 6 is characterized in that in said PC card having the antenna unit claimed in the claim 5, said main body is provided with a reinforcement structure when the antenna unit is in the expanded position. This reinforcement structure is constructed to assure the connection between the elastic connectors of one substrate and the conductor pads in the other substrate.

As a result of this reinforcement structure, when the antenna unit is in the expanded position, the connection between the elastic conductors of one substrate and conductor pads of the other substrate. It avoids the defect in receiving and sending the data due to the poor connection.

The invention according to the claim 7 is characterized in that in said PC card having the antenna unit claimed in the claim 1, both the face and the back of the main body of the PC card on storage part side are a bit dented inside.

It makes possible to push further (inside) from the condition where the antenna unit is completely stored in the unit storage part of the PC card and as a trigger, the antenna unit will jump out from the stored position.

The invention is possible to obtain further advantageous changes and refinements in the scope of the claims without deviating from the spirit of invention. The invention consists these changes and refinements.

### EMBODIMENTS OF THE INVENTION

Preferable usage of the PC card having the antenna unit is described more specifically with the aid of the drawings below.

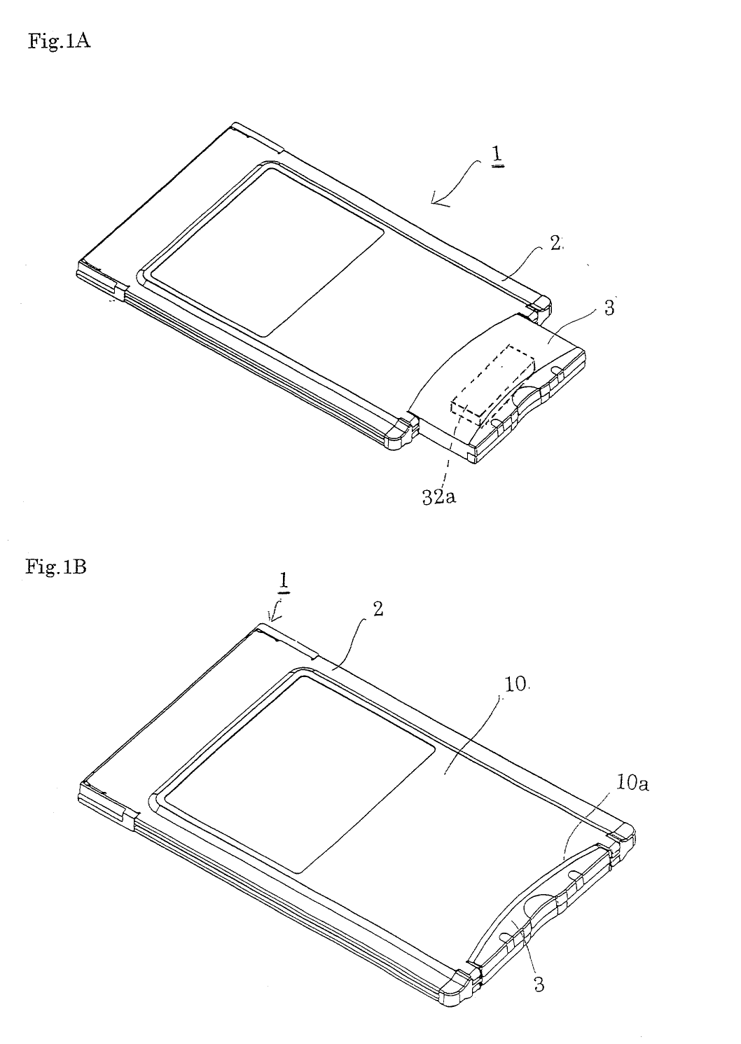

FIG. 1 is a perspective view of one embodiment of the PC card having the antenna according to the present invention. (a) shows the antenna unit in the expanded position when the PC card is being used, and (b) shows the antenna unit in the stored position when the card is not being used.

The PC card having the antenna unit 1 comprises the main body of the PC card 2 and the antenna unit 3. They are manufactured as separate parts and the antenna unit 3 is mounted within the main body of the PC card 2 to have two positions, the expanded position and the stored position. As illustrated in FIG. 1(a), when the PC card is being used, at least the antenna part 32a of the antenna unit 3 is expanded outside of the metallic shield material of the main body of the PC card 2 and retained there. On the other hand, as illustrated in the FIG. 1(b), when the card is not being used, the entire antenna unit 3 is substantially stored inside the main body of the PC card 2 and retained there. When the antenna unit 3 is pressed down deep inside of the PC card 2 from the condition of the FIG. 1(b), the engaging mechanism is lifted, the PC card 2 is pushed out the condition illustrated in the FIG. 1(a) by the force of the spring and stops.

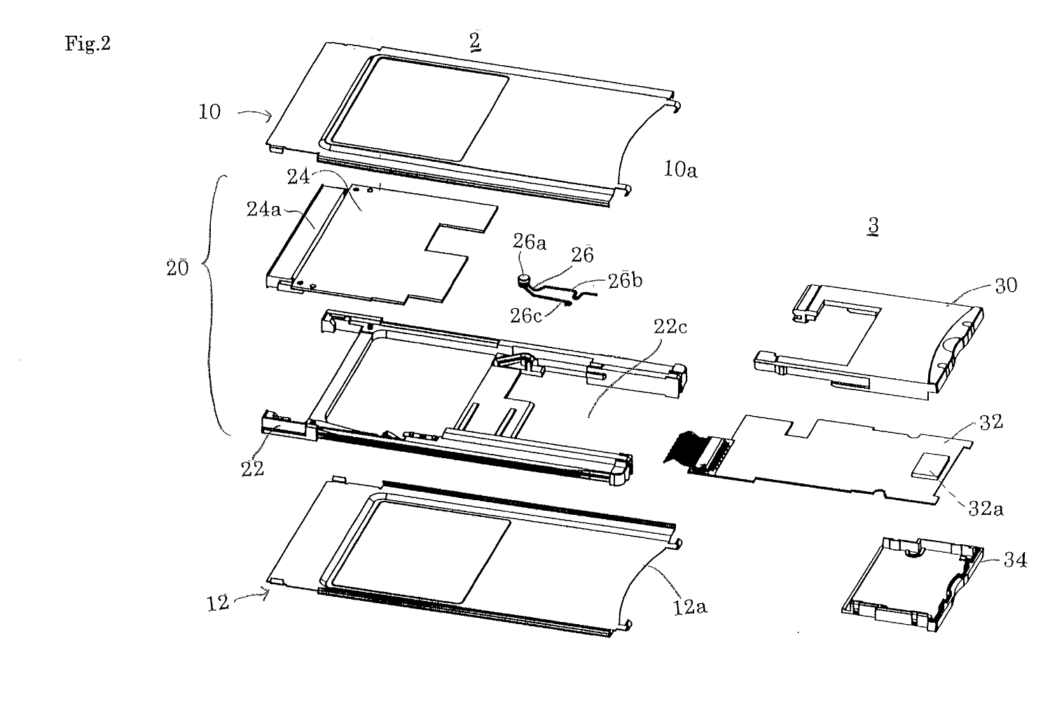

FIG. 2 is a perspective exploded view of main parts of the PC card having the antenna unit illustrated in the FIG. 1.

According to the illustration of the FIG. 2, the PC card 2 in roughly speaking comprises the metallic material upper cover 10 and the lower cover 12, and the core part 20 which is being sandwiched by the covers. The sides of the antenna unit storage part 22c of the upper cover 10 and the lower cover 12 are dented inside in to be arc portion 10a and 12a. By those dents, the antenna unit 3 is possible to be pressed down further inside from the condition where the antenna unit 3 is completely stored in the unit storage part 22c of the PC card 2, illustrated in FIG. 1. And as a trigger, the antenna unit 3 jumps out from the stored position.

The core part 20 includes a plastic frame 22 formed as an integrated structure, and a substrate 24 fixed to the frame 22, and a spring 26. On the other hand, the antenna unit 3 comprises a plastic upper plate 30 and an under plate 34, and an antenna part 32a which is being sandwiched by those plates equipped with the substrate 32.

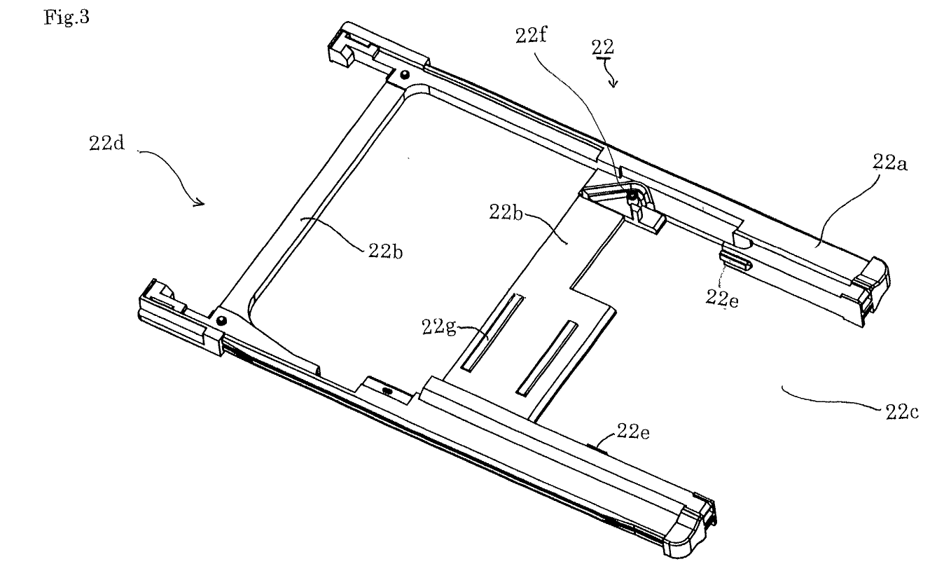

A frame 22 includes a pair of side frame parts 22a, which are located in the distance almost the same as the width of the PC card 1, and the bridge parts 22b which couple strongly at almost in the middle and at a position near the end of the connector side, the side frames 22. As illustrated specifically in the FIG. 3, the center side bridge part 22b is a thin plate-like or board shape, and on top of that, there are 2 rays of bank parts 22g. It is shaped in a thin board to provide a space for elastic connectors 33a, which are fixed on the substrate 32 of the antenna unit 3, to move back and force. By means of this structure, the center side bridge part 22b performs as the reinforcement structure to assure the electrical connection between the PC card 2 and the antenna unit 3 when it is in expanded position as mentioned later.

An open space 22c, formed by a pair of the side frames 22a and the center side bridge part 22b, is used to store the antenna unit 3. By doing so, the thinness of the main body 2 of the PC card is being reached. On the other hand, the open space 22d, formed by a pair of the side frame parts 22a and the connector side bridge 22b, is used to store the connectors 24b, which are fixed on the end part of the substrate 24. As illustrated specifically in the FIG. 3, on a side that faces the open space 22c of the side frame part 22a, there is the projection 22e. As mentioned later, this projection 22e serves as the guide when the antenna unit 3 is being stored in very deep inside the main body 2 of the PC card.

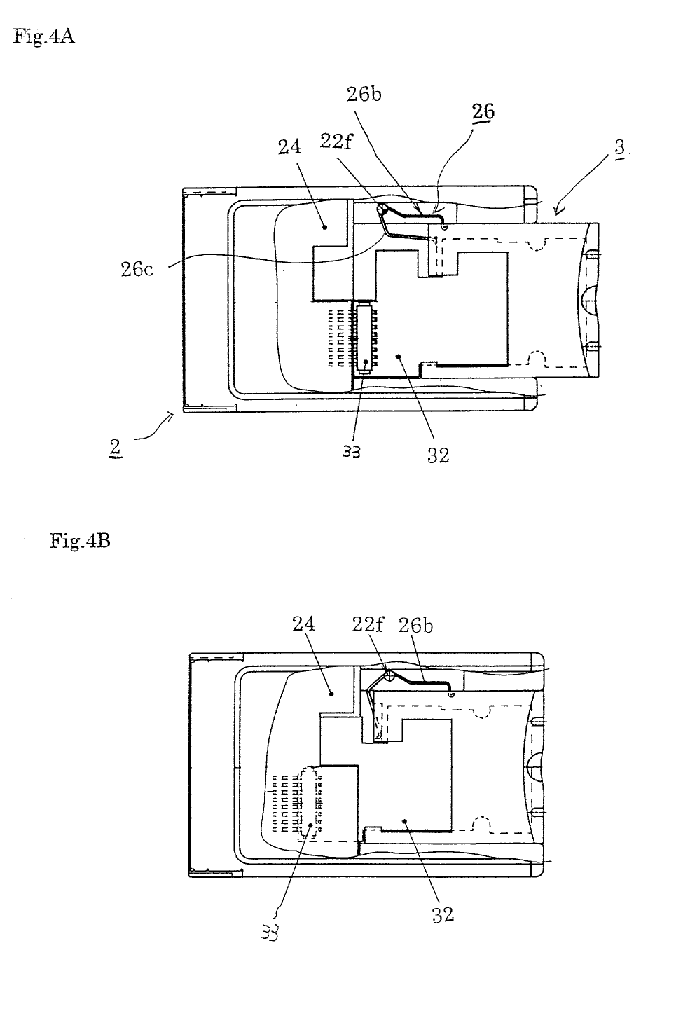

A spring 26 is attached to the post 22f of the side frame part 22a. The spiral part 26a of the spring 26 is inserted to the post part 22f and its extending side legs 26b, 26c are possible to slide along the two adjacent sides of the antenna unit 3. FIG. 4(a) and (b) illustrates the conditions of the spring 26 when the antenna unit 3 is being used (the expanded position) and not being used (the stored position).

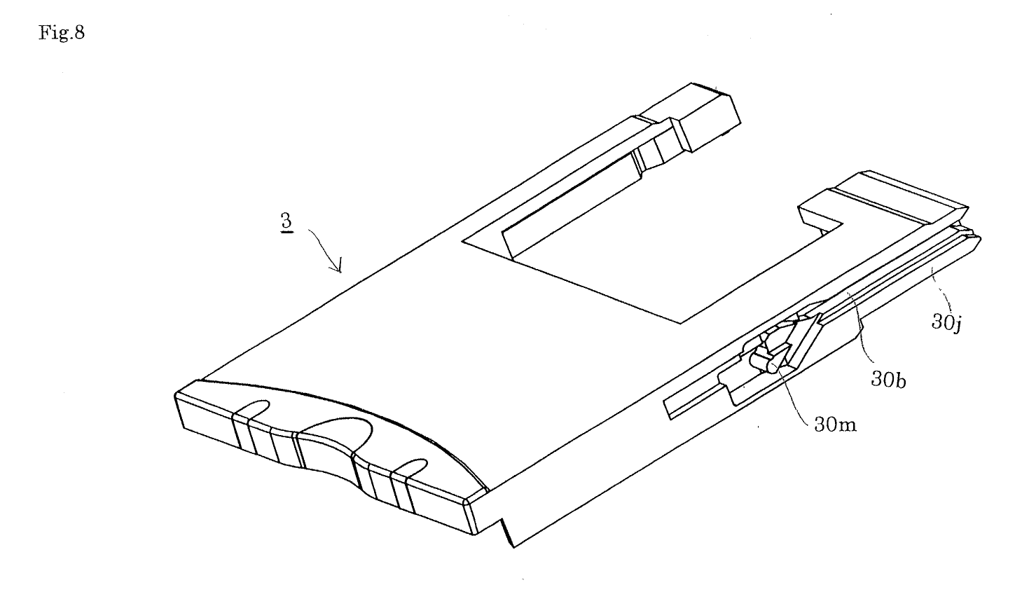

The FIG. 8 is an enlarged perspective view of the opposite side of the upper cover 30, illustrated in the FIG. 2. As illustrated, on an other side wall 3j of the upper cover 30, from the side of the main body 2 PC to inside, there is a spring guide groove 30K, and at the end of it, there is depression 30m. The end part of the extending side leg 26b of the spring 26 falls into this depression 30m, the antenna unit 3 is retained in the stored position relating to the main body 2. When the antenna unit 3 is pressed little bit to inside from this position, the end of the extending side leg 26b of the spring 26 is lifted and then goes deep inside of the spring guide groove 30k from this depression 30m. Upon releasing the finger, the antenna unit 3 is ejected outside of the main body 2 by the elasticity of the spring 26.

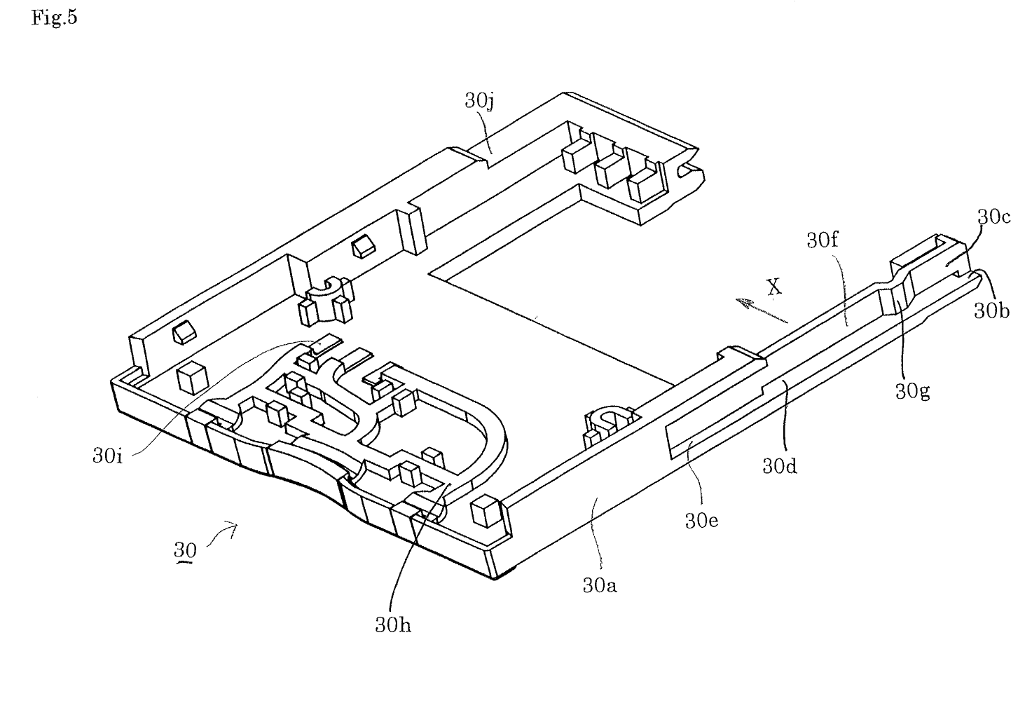

Next, the description of the engaging mechanism constructed between the main body 2 and the antenna unit 3. FIG. 5 is a perspective view of the upper cover 30 placed upside down. As illustrated in the FIG. 5, the side wall 30a is formed along one side of the upper cover 30. The side wall 30a is expanded to the direction of the main body 2, and its bottom part 30b and elevation part 30c are placed forming almost a letter T. The elevation part 30c includes an open space 30d by missing some part of the attachment with the bottom part 30b. The elevation part 30c adjacent to the open space 30d is the bridge part 30f which is supported by its both ends, is capable of bending elastically in the direction of center (the direction of the arrow X) of the upper cover 30. The bridge part 30f also has the protrusion part 30g which protrudes in the direction outside to the side of the upper cover 30.

The projection 22e of the main body 2, mentioned before, is built to move back and force along the guide groove 30e which is formed on the side wall 30a. On the extended line, there is the protruded part 30g. The projection 22e is therefore engaged with the bulge part 30g, preventing the antenna unit from extending over the expanded position and falling out from the main body 2. The bridge part 30f is in the form of bridge in which both ends are supported so it does not damage from the moment force.

Moreover, in the drawing, 30h is the lens that penetrates the light of LED30i to outside and informing the user on the various conditions of PC card 1.

As mentioned above, the main body 2 of the PC card and the antenna unit 3 are manufactured as separate parts. To connect those parts electrically, the substrate 24 of the main body 2 of the PC card and the substrate 32 of the antenna unit 3 are connected by the flexible cable (not illustrated). It is the most general and requires minimum cost to achieve the purpose.

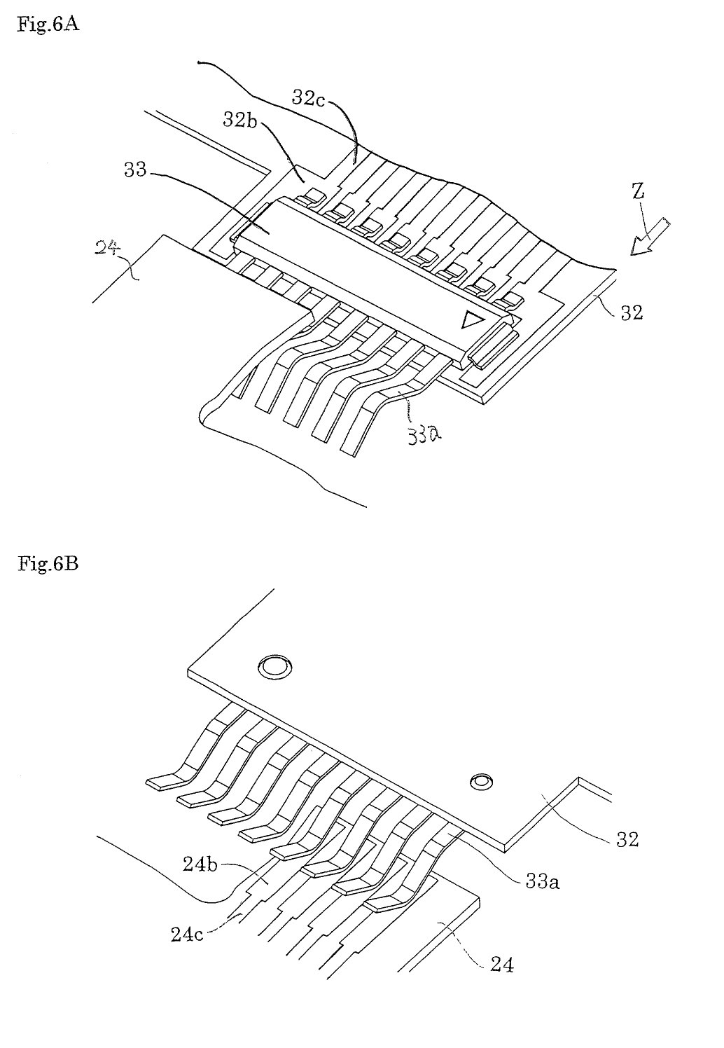

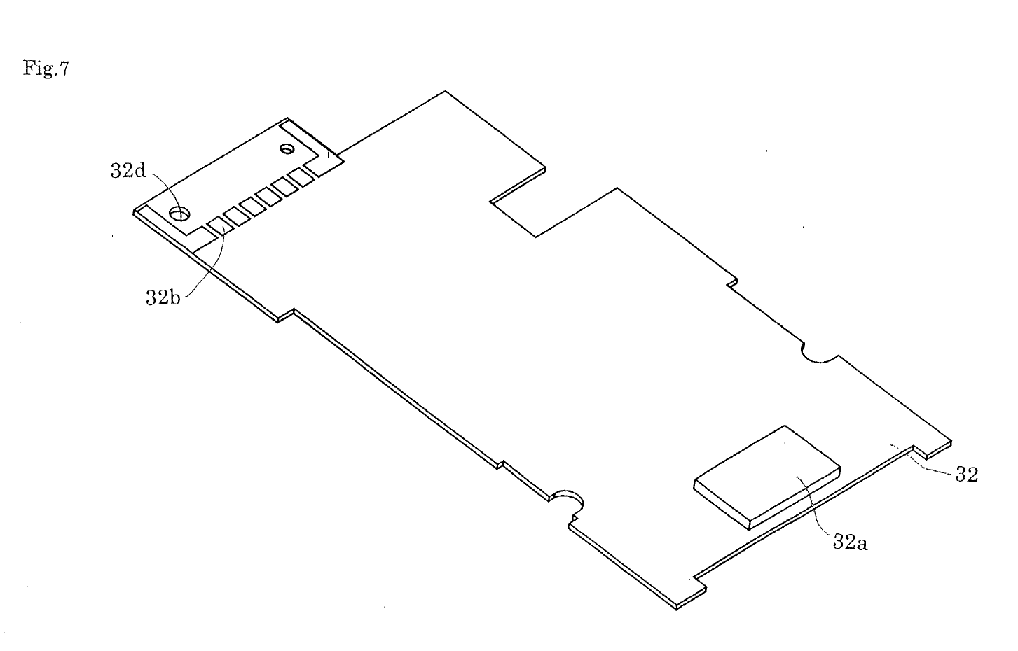

FIG. 6 is a perspective view showing an another embodiment of construction for connecting the substrate of the main body of the PC card and the substrate of the antenna unit. For the substrate 24 of the main body 2 and the substrate 32 of the antenna unit, there are provided with the conductive pads 24b and 32b on the ends of the wired conductive lines 24c and 32c. A prulality of elastic connectors 33a are molded into a connector 33, and the connector 33 is fixed to the substrate 32(FIG. 7) by using setting holes 32d. As a result, one end of each elastic connector 33a attaches the conducting pad 32b of the substrate 32 and electrically conducted. Alternatively, one end of each elastic connector 33a and the conducting pad 32b of the substrate 32 are soldered. When the antenna unit 3, therefore, the substrate 32 moves in the direction of the arrow Z to the position shown in the FIG. 6, or when the PC card 1 is being used, one end of each elastic connector 33a are attached to the conducting pad 24b of the substrate 24 and electrically conducted. At this time, the bank parts 22g on the central side bridge 22b supports the substrate 32. In the consequence of this, the curving of the substrate 32 diminishes and assures the connection to the conductive pad 24b of the substrate 24.

On the other hand, when the antenna unit 3, therefore, the substrate 32 moves in the opposite direction of the arrow Z, one ends of the elastic connectors 33a come off from the positions of the conductive pads 24b of the substrate 24 and the electric connection goes off.

As mentioned above, when the antenna unit is in the expanded position, the main body 2 and the antenna unit 3 are electrically connected, but when this antenna unit moves to the stored position, the connection goes off. Therefore, when carrying the note type computer with a PC card inserted in the PC card slot and the antenna unit 3 is stored inside the main body 2, the wrong operation of catching the radio wave is avoided.

### EFFECT OF THE INVENTION

With the invention according to the claim 1, inside the thin and plate-like main body of the PC card, almost all of the top and bottom sides of which are covered with the radio wave shielding material, there is provided with the antenna unit storage part or slot into which the antenna is mounted extensively. In time of using, at least the antenna part of the antenna unit is expanded to outside of the radio wave shielding material and retained and is able to receive and send the radio wave. In time of not using, the entire antenna unit is substantially stored and retained in the stored position, and is able to achieve the minimization in size and thinness in height. A PC card substantially becomes a thin plate-like board without any projection, result in being easy to keep PC cards on top of each other without taking much space.

With the invention according to the claim 2 wherein the PC card having the antenna unit in the claim 1 includes the retainer mechanism between the main body of the PC card and the antenna unit, the antenna unit is prevented from falling out of the main body of the PC card extending over the expanded position.

With the invention according to the claim 3 wherein the retainer mechanism of the PC card having the antenna unit in the claim 2, comprises the combination of the projection which is build either on the main body of the PC card or the antenna unit, and the elastic bridge part which is formed as a part of the other frame structure and is provided with a protrusion entering into the extended line of the passage where the projection passes through, the bridge has enough elasticity and at a same time, has advantage of not breaking in supporting the weight because it is supported by both ends of the bridge.

With the invention according to the claim 4 wherein the main body of the PC card and the antenna unit of the PC card having the antenna unit described in one of the claim 1-3, are electrically connected by the flexible cable, it is an advantage of connecting electrically easily and with little cost.

With the invention according to the claim 5 wherein the main body of the PC card and the antenna unit of the PC card having the antenna unit described in any one of the claim 1-3, are electrically connected by the pressure of the elastic connectors which are set sticking out from the one substrate and the conductive pads which are formed on the other substrate, they are electrically connected when the antenna unit is in the expanded position while the connection is cut off when it moves to the stored position.

With the invention according to the claim 6 wherein the main body of the PC card having the antenna unit described in the claim 5, is provided with the reinforcement structure to assure the connection between the elastic connectors of one substrate and the conductive pads of the other substrate when the antenna unit is in the expanded position, it is an advantage not having a defect in receiving and sending data due to the poor connection.

With the invention according to the claim 7 wherein both the face and back of the main body of the PC card on storage part side are provided with a bit insidely dented portion, it is capable of pushing further (inside) from the condition where the antenna unit is completely stored in the unit storage part or slot.

### BRIEF DESCRIPTION OF THE DRAWINGS

(FIG. 1): is a squint diagram of one practical form of a card having an antenna unit. (a) is a diagram of the antenna unit in the expanded position in time of using, and (b) is the antenna unit in the stored position in time of not using.

(FIG. 2): is a diagram takes in pieces by main parts of a PC card having an antenna unit.

(FIG. 3): is a perspective view illustrating the frame shown in FIG. 2.

(FIG. 4): is the condition of the spring 26 in the antenna unit 3 is in the usage (expanded position) and not being used (stored position).

(FIG. 5): is the upside down squint diagram of the top cover illustrated in the FIG. 2. (FIG. 6), (a) and (b): are the diagrams looking down on and up on the structure of connecting elastically the substrate of the main body of the PC card and the substrate of the antenna unit.

(FIG. 7): is a perspective view showing the details of the substrate 32 shown in the FIG. 2.

(FIG. 8): is an expanded diagram of the top cover 30 looking from the opposite direction of the FIG. 2.

(FIG. 9): is a diagram of the typical type of the former PC card having an antenna unit.

(FIG. 10): is a perspective view for explaining the condition of inserting the PC card into the note type computer.

### DESCRIPTION OF THE REFERENCE NUMERALS

1. PC card

2. Main body of the PC card

3. Antenna unit

10 Top cover

12 Lower cover

20 Core material

22 Frame

24 Substrate

26 Spring

30 Upper cover

32 Substrate

32a antenna portion

34 Under cover

1. A PC card having an antenna unit wherein the most of the top and bottom parts of a thin-plate (board) like main body of the card is covered by the radio wave shield material, a stored portion of the antenna unit is build in the main body; in this stored portion of the antenna unit, the PC card having the antenna unit that is possible to expand therefrom is equipped, and in time of using the computer, at least the antenna part of the antenna unit is expanded to outside of the radio wave shield material of the main body of the card, and the antenna unit is retained at an expanded position to receive and send the radio wave, and in time of not using, the entire antenna unit is substantially encapsulated inside the main body of the card and retained at a stored position:

2. The invention according to the claim 2 is characterized in that said PC card having the antenna unit described in the claim 1 is provided with a retainer mechanism between the main body of the PC card and the antenna unit whereby the antenna unit is kept from expanding further than the expanded position where it might be dropped off.

3. The invention according to the claim 3 is characterized in that in said PC card having the antenna unit claimed in the claim 2 said retainer mechanism comprises a combination of a projection build either the main body of the card or the antenna unit and an elastic bridge part which is formed as a part of the other frame structure, and is provided with a protrusion entering into an extended line of a passage where said projection passes through.

4. The invention according to the claim 4 is characterized in that in said PC card having the antenna unit claimed in any one of the claim 1-3, the main body of the PC card and the antenna unit is electrically connected by a flexible cable.

5. The invention according to the claim 5 is characterized in that in said PC card having the antenna unit claimed in any one of the claims 1-3, the main body of the PC card and the antenna unit are electrically connected by a mechanical connecting pressure created by elastic connectors, which are projecting from a substrate, and the conductor pads which are equipped in the other substrate. When the antenna unit is in the expanded position, the main body and the antenna unit are electrically connected, and when the antenna unit is moved to the stored position, the connection is cut off.

6. The invention according to the claim 6 is characterized in that in said PC card having the antenna unit claimed in the claim 5, said main body is provided with a reinforcement structure when the antenna unit is in the expanded position. This reinforcement structure is constructed to assure the connection between the elastic connectors of one substrate and the conductor pads in the other substrate.

7. The invention according to the claim 7 is characterized in that in said PC card having the antenna unit claimed in the claim 1, both the face and the back of the main body of the PC card on storage part side are a bit dented inside.
